(19) United States
(12) Patent Application Publication
(10) Pub. No.: US 2011/0032564 A1
(43) Pub. Date: Feb. 10, 2011

(54) INFORMATION PROCESSING APPARATUS, PRINTING APPARATUS, IMAGE PROCESSING COOPERATION SYSTEM, CONTROL METHOD, AND COMPUTER-READABLE MEDIUM

(75) Inventor: Masakazu Kitora, Kawasaki-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/838,321

(22) Filed: Jul. 16, 2010

(30) Foreign Application Priority Data
Aug. 4, 2009 (JP) 2009-181967

(51) Int. Cl. G06F 3/12

(52) U.S. Cl. 358/1.15

(57) ABSTRACT

An information processing apparatus for generating output data to be output to a printing apparatus, which executes print processing or output processing to a display apparatus according to a definition described in the output data, comprises a holding unit which holds information of the printing apparatus as port information of the printing apparatus, and holds information of the printing apparatus as port information of the display apparatus; a describing unit which describes, in the output data, a definition indicating that the display apparatus outputs the output data when the display apparatus is designated as an output destination of the output data, and a definition indicating that the printing apparatus outputs the output data when the printing apparatus is designated as an output destination of the output data; and an output unit which outputs the output data to the printing apparatus.

### BACKGROUND OF THE INVENTION

1. Field of the Invention

The present invention relates to an image processing cooperation system that includes an information processing apparatus, display apparatus, and printing apparatus.

2. Description of the Related Art

A printing apparatus, which is known as a MFP (Multi Function Peripheral), and can make data accesses (read/write accesses) to a storage mechanism and an external apparatus via a network, is known. Also, a projector, which can receive data from an external apparatus via a network, is known. For example, in case of a conventional projector, a PC is brought into a meeting room, and image data on the PC are displayed while operating the PC on site. Japanese Patent Laid-Open No. 2005-115926 discloses a technique that allows another I/F to set respective I/Fs when a device includes print functions using a plurality of I/Fs. Note that an embodiment of Japanese Patent Laid-Open No. 2005-115926 allows a wireless LAN I/F to be set using a USB I/F. Also, Japanese Patent Laid-Open presentation system using a PC and a projector having a network I/F.

In order to improve the added value of the projector including the network I/F, it is demanded to provide a user method that can enhance user's convenience by allowing image display in a PC-less manner, that is, without using any PC. To meet this demand, the projector has to include new unit required to send images in a PC-less manner, or it has to operate in cooperation with a device that executes required processes in place of the projector.

Thus, the projector itself includes only an RIP function, and allows to display images in a PC-less manner in cooperation with a storage function and data analysis unit included in an MFP. To implement this, the present invention adopts the following arrangement.

### SUMMARY OF THE INVENTION

According to one aspect of the present invention, there is provided an information processing apparatus for generating output data to be output to a printing apparatus, which executes print processing or output processing to a display apparatus according to a definition described in the output data, comprising: a holding unit which holds information of the printing apparatus as port information of the printing apparatus, and holds information of the printing apparatus as port information of the display apparatus; a describing unit which describes, in the output data, a definition indicating that the display apparatus outputs the output data when the display apparatus is designated as an output destination of the output data, and a definition indicating that the printing apparatus outputs the output data when the printing apparatus is designated as an output destination of the output data; and an output unit which outputs the output data to the printing apparatus.

According to the present invention, even when a printing apparatus and display apparatus are different devices, an identical user interface can be used in print and display operations, thus improving the user's convenience.

Further features of the present invention will become apparent from the following description of exemplary embodiments (with reference to the attached drawings).

### BRIEF DESCRIPTION OF THE DRAWINGS

FIG. 1 is a block diagram showing an example of the arrangement of an image processing cooperation system (MFP) according to an embodiment of the present invention;

FIG. 2 is a flowchart showing a driver installation sequence according to the embodiment;

FIGS. 3A to 3F are views showing window examples of a driver installer according to the embodiment;

FIG. 4 is a flowchart showing the sequence of PDL data output processing in a host according to the embodiment;

FIG. 5 is a view showing a description example of PDL data according to the embodiment;

FIG. 6 is a flowchart showing the sequence of PDL analysis processing in a printer according to the embodiment; and

FIG. 7 is a flowchart showing the sequence of display processing in a projector according to the embodiment.

### DESCRIPTION OF THE EMBODIMENTS

An image processing cooperation system according to an embodiment of the present invention will be described hereinafter with reference to the drawings.

[System Overview]

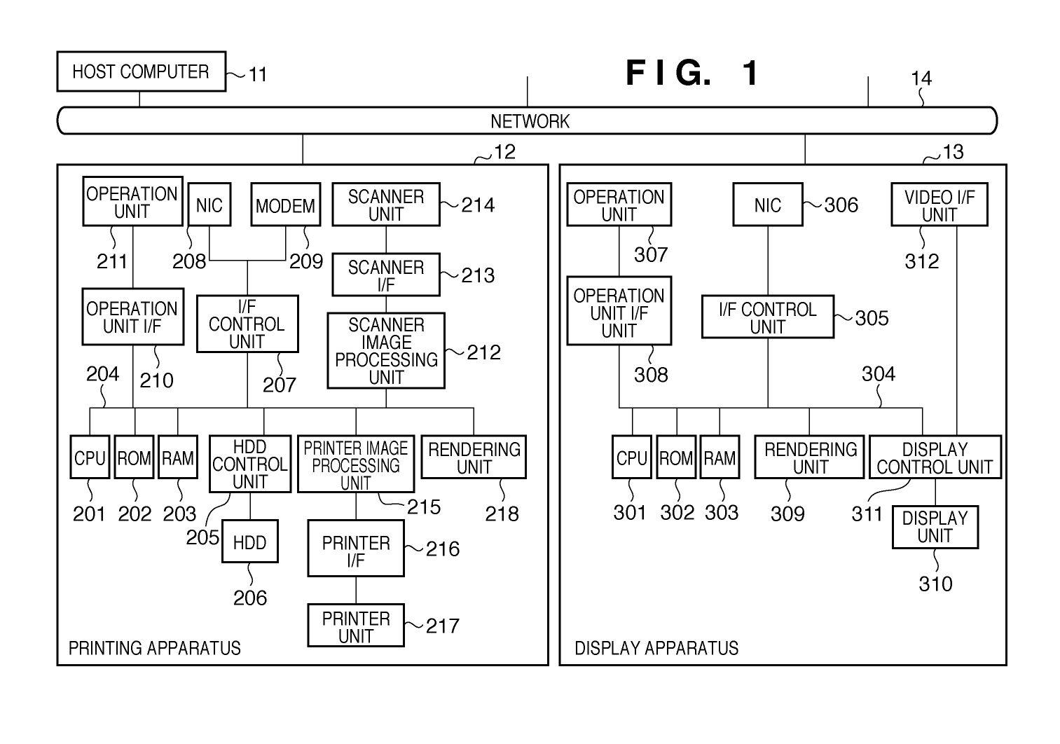

FIG. 1 is a block diagram showing an image processing cooperation system of the present invention. A host computer 11 as an information processing apparatus has a function of transferring image data. In general, a general-purpose PC or server is used. The host computer 11, a printing apparatus 12, and a display apparatus 13 are connected to each other via a network 14.

The internal arrangement of the printing apparatus 12 will be described below. A CPU 201 is a controller used to control the overall printing apparatus 12. The CPU 201 launches an OS (Operating System) by a boot program stored in a ROM 202. The CPU 201 runs a controller program and various application programs stored in a large-capacity storage (HDD) 206 on this OS. The CPU 201 is connected to respective units via internal buses such as a data bus 204. A RAM 203 serves as temporary storage areas such as a main memory and work area of the CPU 201. Furthermore, the RAM 203 is used as a temporary storage area for image processing. An I/F control unit 207 controls a network I/F such as a NIC (Network Interface Card) 208 to exchange various data such as image data with a network such as a LAN. The I/F control unit 207 also controls a modem 209 to exchange data with the telephone line. An operation unit I/F 210 inputs user operation instructions from an operation unit 211 including a touch panel and hardware keys. The operation unit I/F 210 controls the operation unit 211 including an LCD or CRT to display an operation window for the user.

A scanner image processing unit 212 corrects, modifies, and edits image data received from a scanner unit 214 via a scanner I/F 213. Note that the scanner image processing unit 212 determines whether the received image data is that of a color or monochrome original, and a text or photo original. The scanner image processing unit 212 appends the determination result to the image data. Such appended information will be referred to as “attribute data” hereinafter. A printer image processing unit 215 executes print output image processing, and sends bitmap data to a printer unit 217 via a printer I/F 216. A rendering unit 218 generates bitmap data used as a print image. Note that the rendering unit 218 generates bitmap data by interpreting display list data (DL) generated by the aforementioned CPU 201. The display apparatus 13 used in the present invention corresponds to, for example, a projector. A CPU 301 is a controller used to control the overall projector 13. The CPU 301 launches an OS (Operating System) by a boot program stored in a ROM 302. The CPU 301 runs a control program and various applications on this OS. The CPU 301 is connected to a data bus 304. A RAM 303 serves as temporary storage areas such as a main memory and work area of the CPU 301. Furthermore, the RAM 303 is also used as a temporary storage area in image processing. An I/F control unit 305 controls a network I/F such as a NIC (Network Interface Card) 306 to exchange various data such as image data with a network such as a LAN.

An operation unit I/F 308 inputs user operation instructions from an operation unit 307 including hardware keys and a remote controller. The operation unit 307 communicates with a display control unit 311 to display an operation window on an external screen from a display unit 310. A rendering unit 309 generates bitmap data used as a display image. Note that the rendering unit 309 generates bitmap data by interpreting display list data received via the NIC 306. The display unit 310 projects an image of the bitmap data generated by the rendering unit 309 onto the external screen via the display control unit 311. A Video I/F unit 312 receives an external video signal, and projects an image from the display unit 310 via the display control unit 311. The display control unit 311 decides display contents to be displayed by the display unit 310 from the operation window sent from the operation unit I/F 308, bitmap data rendered by the rendering unit 309, a video signal input from the Video I/F unit 312, and the like, based on an instruction of the CPU 301. Note that the system of this embodiment includes the printer, projector, and host computer. However, the present invention is not limited to those apparatuses, and different apparatuses may be included or a plurality of projectors and printers may be included.

[Driver Installation]

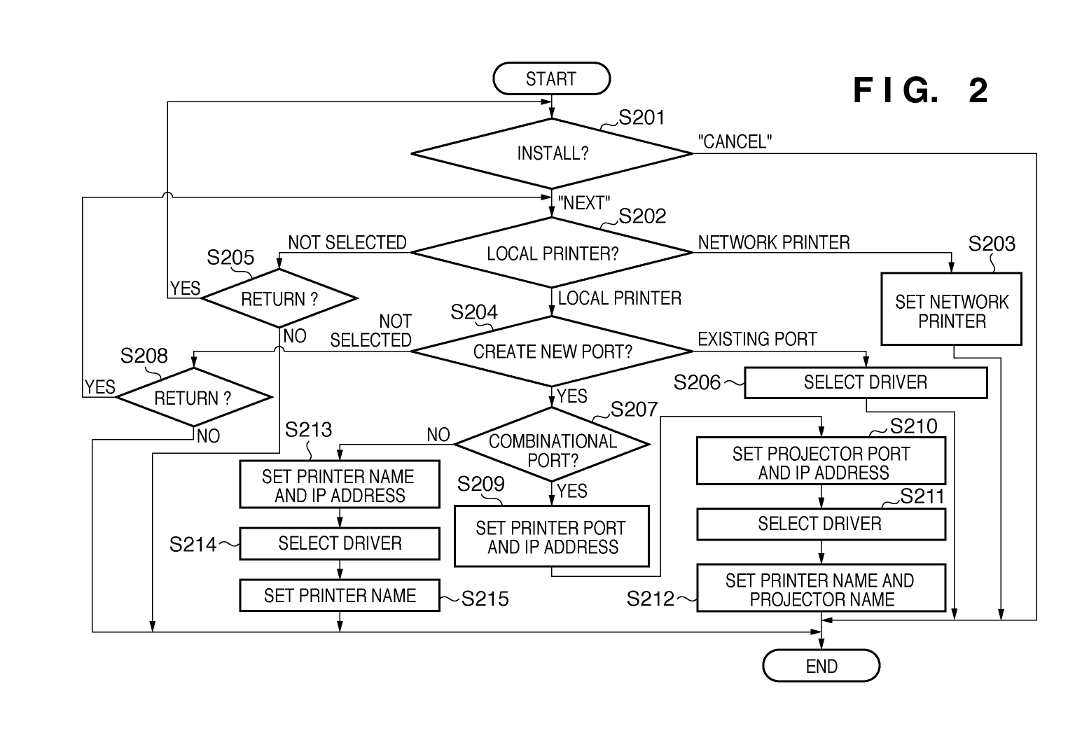

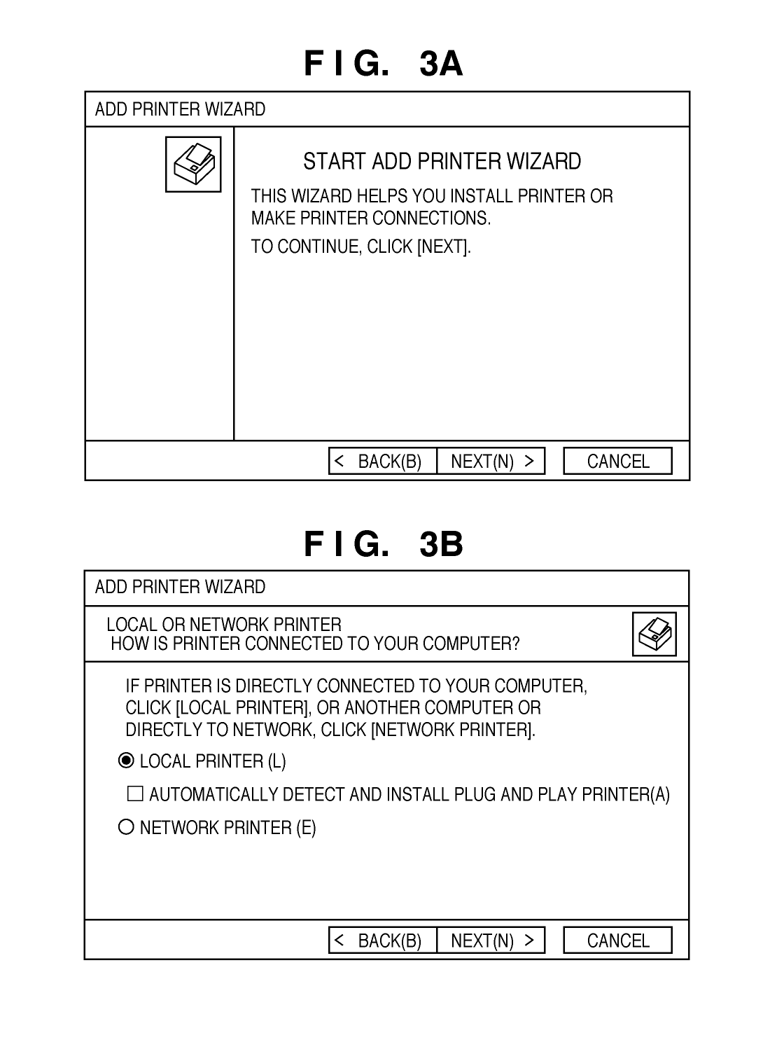

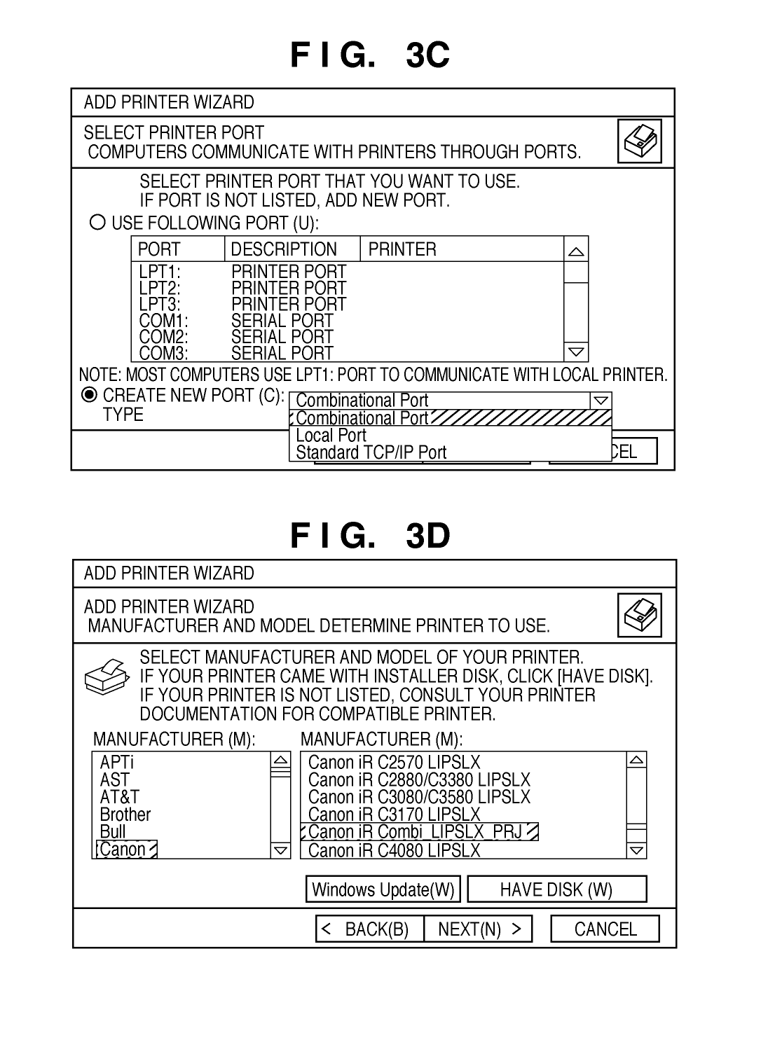

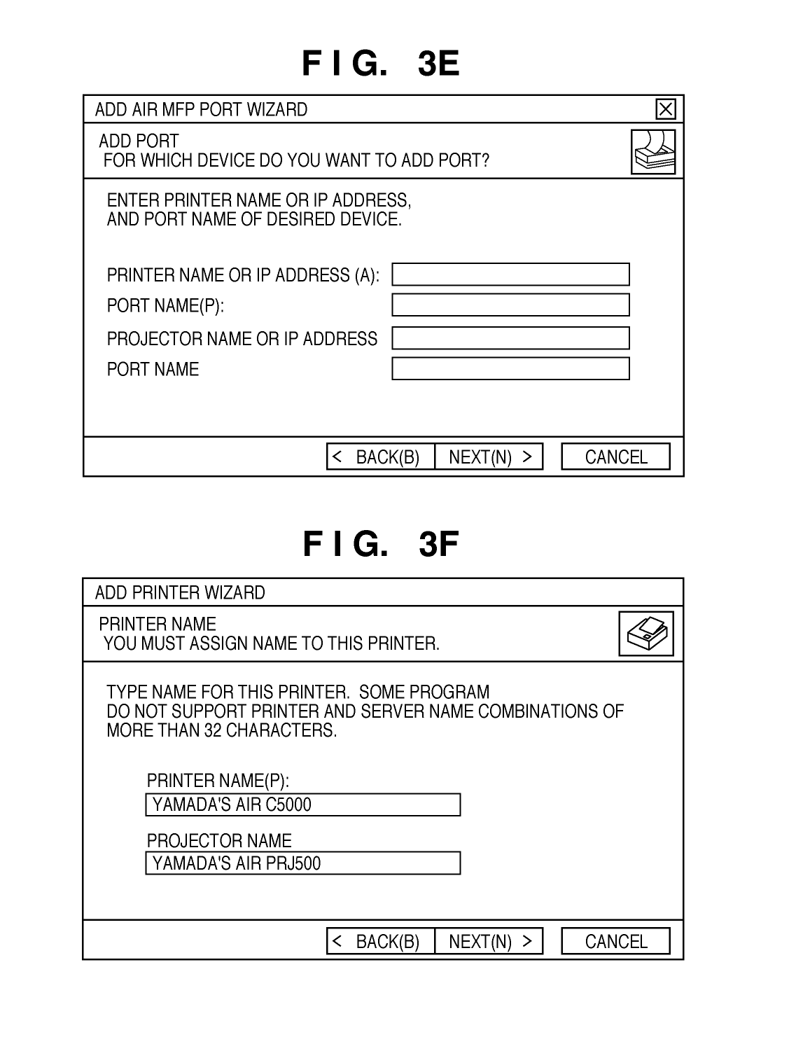

An installation method of a driver required to transfer data from the host computer 11 to the printing apparatus 12 and display apparatus 13 will be described below. FIG. 2 is a flowchart of installation processing upon installing the driver. The following sequence will be described under the assumption that this driver uses a printer as the printing apparatus 12 and a projector as the display apparatus 13. FIGS. 3A to 3F show window examples of a device installer.

When the user selects installation of a driver from a menu on the host computer 11 in S201, the host computer 11 displays a window shown in FIG. 3A and prompts the user to select whether or not to install a driver. If the user selects “next”, the process advances to step S202. If the user selects “cancel”, this processing sequence ends. In step S202, the host computer 11 confirms a connection mode of a printer. FIG. 3B shows a selection window example displayed on the host computer. If the user selects a “local printer” button, the process advances to step S204; if he or she selects a “network printer” button, the process advances to step S203. If the user does not select any button, the process advances to step S205. In step S203, if a network printer is set in step S202, the host computer searches for accessible printers on the network, and lists them up on a menu. When the user selects a desired printer from the menu, the setting processing is complete.

If the user selects a local printer in step S202, he or she sets a port used to transfer data between the local printer and host computer in step S204. The user can set a port by selecting it from existing ports or by creating a new port. In case of the selection window example in FIG. 3C, when the user wants to use an existing port, he or she selects a “use following port” button, selects a desired port from displayed ports, and then presses a “next” button. After that, the process advances to step S206. When the user wants to create a new port, he or she selects a “create new port” button, selects a port of a desired type from a pull-down menu, and then presses the “next” button. After that, the process advances to step S207. The user often wants to abort the installation for certain reasons. Hence, in step S205, in the window example in FIG. 3B, the user can return to the previous window or can promptly terminate the installation. If the user selects a “return” button, the process returns to step S201; if he or she selects a “cancel” button, the installation is aborted, and the window display operation also ends.

If the user selects use of the existing port in step S204, the host computer readily executes driver setting processing in step S206, as shown in the window example of FIG. 3D. When the user selects a desired driver from the window shown in FIG. 3D, the setting processing is complete. If the user wants to create a new port, a port type has to be decided in step S207. For example, in case of this embodiment, three different ports “Combinational Port”, “Local Port”, and “Standard TCP/IP Port” are prepared, as listed in FIG. 3C. The “Combinational Port” is a port of a type used when the printer and projector are controlled to cooperate like in the present invention. The “Local Port” is a port of a type directly connected to the host computer, and the “Standard TCP/IP Port” is a port of a type prepared by a printer connected on a network that supports a TCP/IP protocol. If the user selects “Combinational Port”, the process advances to step S209; if he or she selects another port type, the process advances to step S213. Note that this process implements an output port information holding unit which holds user's setting values for output ports in association with each other.

In step S208, if the user wants to abort the installation in step S204, he or she selects a “return” button on the window example in FIG. 3C, and the process returns to step S202; he or she selects a “cancel” button to abort and terminate the installation, as in step S205. In step S209, the user proceeds with the setting of “Combinational Port” according to the window example in FIG. 3E. The user sets an IP address and port name of a printer to be used. After that, the process advances to step S210. Note that various kinds of set information are held in association with each other. In step S210, in case of “Combinational Port”, the user sets an IP address and port name of the projector which cooperates with the printer. With this setting, the IP address of the printer is set as the port name of the printer, and is also set as the port name of the projector. Note that the IP address of the projector set in this step is appended to PDL data generated when the user issues an output instruction while designating the projector. The user can simultaneously set the printer and projector in this way, thus reducing the load on the user. After the setting of the projector is made, the process advances to step S211. Pieces of information input in step S210 are also held in association with each other. In step S211, the user selects a driver to be used. The selection method is the same as that in step S206. After that, the process advances to step S212.

In step S212, the user sets a printer name and projector name for the printer and projector, whose driver is to be installed, as shown in the window example in FIG. 3F. The printer and projector names set on this window are registered as the names of printer and projector icons which appear on the window of the host computer. The installation processing of the driver for controlling the printer and projector to cooperate is complete after execution of this step. In steps S213 to S215, the user installs a driver for a printer alone in a conventional manner in place of that for the printer and projector. In step S213, the user sets a printer name and IP address. A window which has the same format as that in FIG. 3E except for projector items is displayed. In step S214, the user selects a printer driver in the same manner as in step S211. After that, the process advances to step S215. In step S215, the user sets a name of a printer icon which appears on the window of the host computer, as in step S213. The driver setting processing for a printer alone is complete after execution of this step. Note that steps S209 to S215 may also include a step of canceling or aborting the installation as in steps S202 and S204.

[PDL Output Operation Sequence]

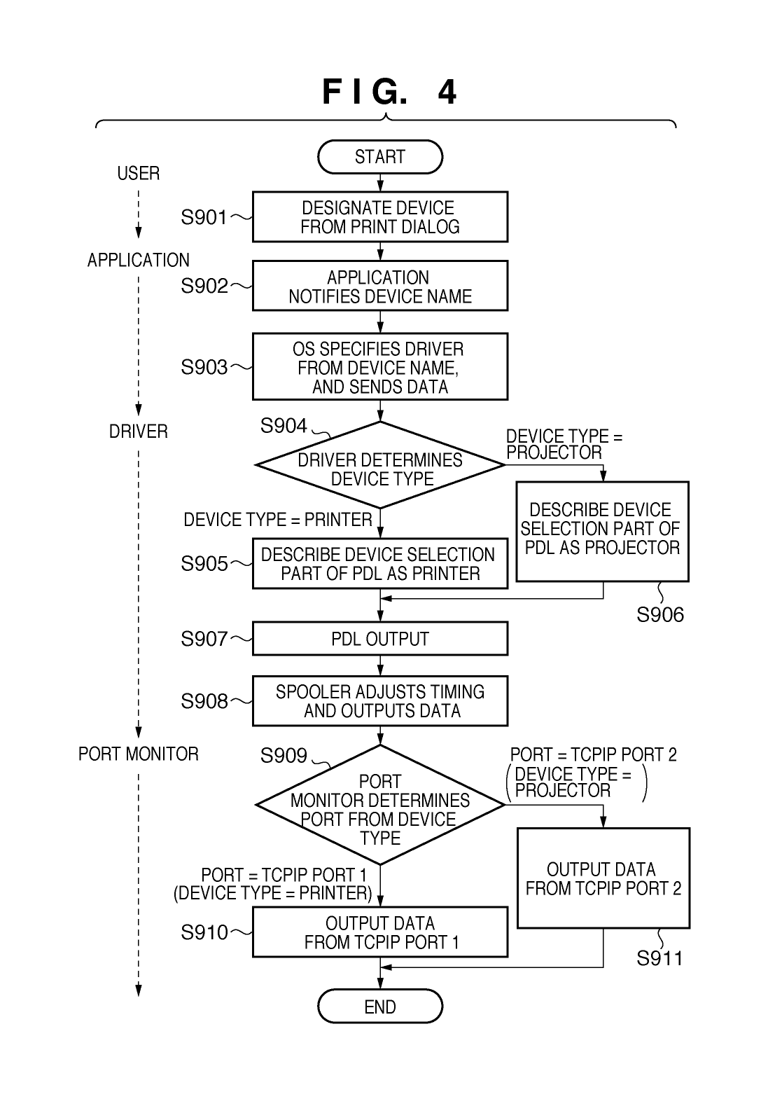

The output sequence of PDL (Page Description Language) data as output data using the driver installed by the aforementioned method will be described below. FIG. 4 is a flowchart of the PDL output processing. Arrows on the left side of FIG. 4 indicate main bodies of the processes. In step S901, when the user wants to output data from an application running on the host computer 11 to the printing apparatus 12, he or she designates a device from a print dialog displayed on a monitor by the application. In step S902, the application notifies the OS of a device name of the device designated by the user. Also, the application generates print data including a series of drawing commands. In step S903, the OS receives information of the device name from the application, and specifies a corresponding driver. Furthermore, the OS sends the device name and print data to the specified driver. In step S904, the driver determines a device type from the received device name. The device type is related to the projector or printer name set at the time of installation of the driver. If the device name is that registered as the printer name at the time of installation (that is, device type=printer), the processes advances to step S905. Conversely, if the device name is registered as the projector name at the time of installation (that is, device type=projector), the process advances to step S906. This process implements a device determination unit. In step S905 or S906, the driver generates PDL data.

In step S905, since the driver receives a printer output destination as a result of determination of the device type, it generates a PDL description by describing setting values for the printer. This process implements a print describing unit. A detailed example of the PDL description will be described later. After that, the process advances to step S907. In step S906, since the driver receives a projector output designation as a result of determination of the device type, it generates a PDL description by describing setting values for the projector. This process implements a display describing unit. After that, the process advances to step S907. In step S907, the driver sends the generated PDL data to a spooler which runs on the host computer. After that, the process advances to step S908. In step S908, the spooler temporarily saves the data sent from the driver. Then, the spooler adjusts a sending timing to a port monitor, and sends the received data to the port monitor as soon as print processing executed at that time ends. After that, the process advances to step S909. In step S909, the port monitor specifies a port number of a port which is designated by the data sent from the spooler as a sending destination.

The “Combinational Port” used in the present invention includes a plurality of sending destinations, and a designated sending destination is determined based on the device type to switch an output port. In this embodiment, when the device type is “printer”, a port is switched to a TCPIP port 1; when the device type is “projector”, it is switched to a TCPIP port 2. In the description of this embodiment, two TCPIP ports are used. However, the present invention is not limited to this, and two or more ports may be used. If the port number destination corresponds to the TCPIP port 1 (that is, device type=printer), the process advances to step S910; if it corresponds to the TCPIP port 2 (that is, device type=projector), the process advances to step S911. When the device type is “printer”, data is output from the port 1 in step S910. When the device type is “projector”, data is output from the port 2 in step S911. Note that since port information of the printing apparatus is set for the port 2, the PDL data is output to the printing apparatus. Also, the generated PDL data includes the IP address of the projector.

[Detailed Description of PDL]

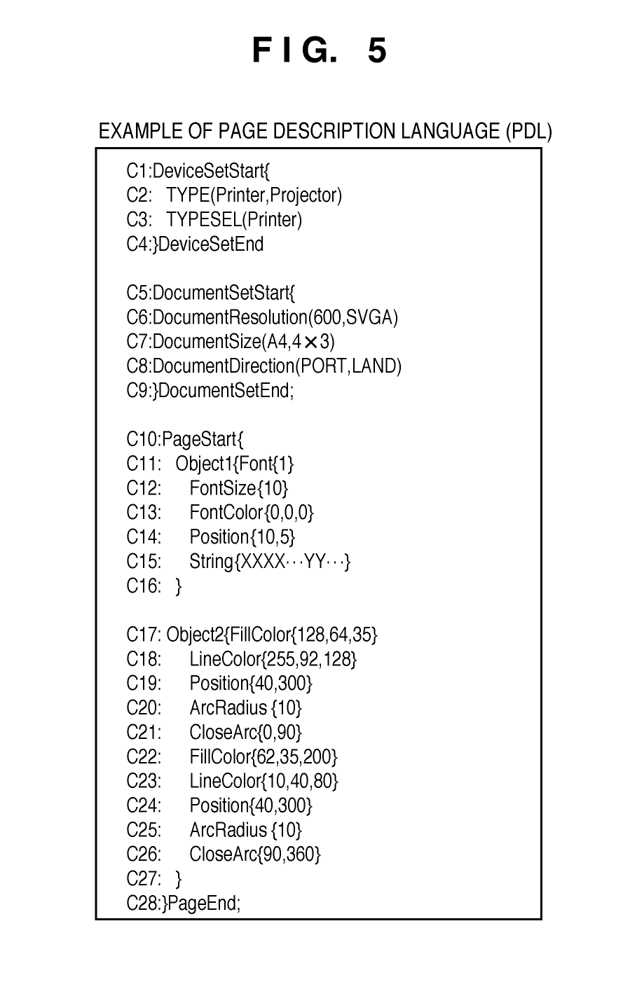

Details of the PDL data used in the present invention will be described below. FIG. 5 shows an example of the PDL description. The output format of output data is defined using PDL data. Commands C1 to C4 are commands associated with device settings. C1 and C4 represent the start and end of commands associated with the device settings. A command C2 describes a device type that this PDL data can support. In case of this description example, two types of devices, that is, “Printer” and “Projector” are supported. Note that when the projector is designated, the IP address of the projector is included. A command C3 indicates a type of a selected device, and this description example indicates that “Printer” is designated. In this embodiment, this description part will be referred to as a device selection part.

C5 to C9 are commands associated with document settings. Commands C5 and C9 represent the start and end of commands associated with the document settings. C6 is a command that represents a document output resolution, and describes setting values corresponding to respective devices. In case of this description example, the command C6 describes printer and projector setting values. The printer setting value is “600” (unit: dpi), and the projector setting value is “SVGA” (unit: pixels; this value means 800 pixels×600 pixels).

A command C7 describes setting values associated with the size of an output image. The command C7 describes setting values for respective devices as in C6. In case of this description example, the command C7 describes printer and projector setting values. The printer setting value includes a setting of a paper size (A4 in this description example). The projector setting value includes a setting of an aspect ratio (4×3 in this description example). A next command C8 indicates a document orientation. The command C8 describes setting values corresponding to respective devices as in C6. In case of this description example, “portrait” and “landscape” are commonly available as printer and projector setting values. In case of this description example, the printer setting value indicates “portrait (PORT)”, and the projector setting value indicates “landscape (LAND)”.

C10 to C28 are commands that represent entities of data in a document. C10 and C28 are commands indicating the start and end of a page. C11 and C16 are commands indicating the start and end of drawing commands of an object 1 (Object1), and C17 and C27 are commands indicating the start and end of drawing commands of an object 2 (Object2). C11 is a command which sets a font type, and selects a font “1”. C12 is a command which sets a font size, and selects a size “10 points”. C13 is a command which sets a font color, and designates luminance values of R (red), G (green), and B (blue) color components in turn. Assume that this luminance value is quantized by 256 levels ranging from 0 to 255. C14 is a command which indicates the coordinates of a character drawing start position. C15 is a command which represents a character string (XXXXX . . . YYY . . . ) to be actually drawn. The coordinate position is designated to have an upper left position of a tile as a reference point. In this case, it is set to start drawing of characters from a position of coordinates {10, 5}.

A command C17 indicates a fill color of a plane in graphic rendering. The color is designated in the same manner as the font color. A command C18 designates a color of a line in graphic rendering. A command C19 indicates coordinates of a position where a graphic is to be drawn. C20 is a command which designates a radius upon drawing an arc, and represents a “10” coordinate unit in this case. A command C21 draws a closed arc. Two parameters in the command indicate drawing start and end angles upon drawing the arc. Assuming that vertical information is 0°, this command indicates drawing of an arc from 0° to 90° in this case. Commands C22 to C26 designate colors of a plane and line, a position, and the like in graphic rendering as in C17 to C21.

[Operation Sequence of Printer in Output Mode]

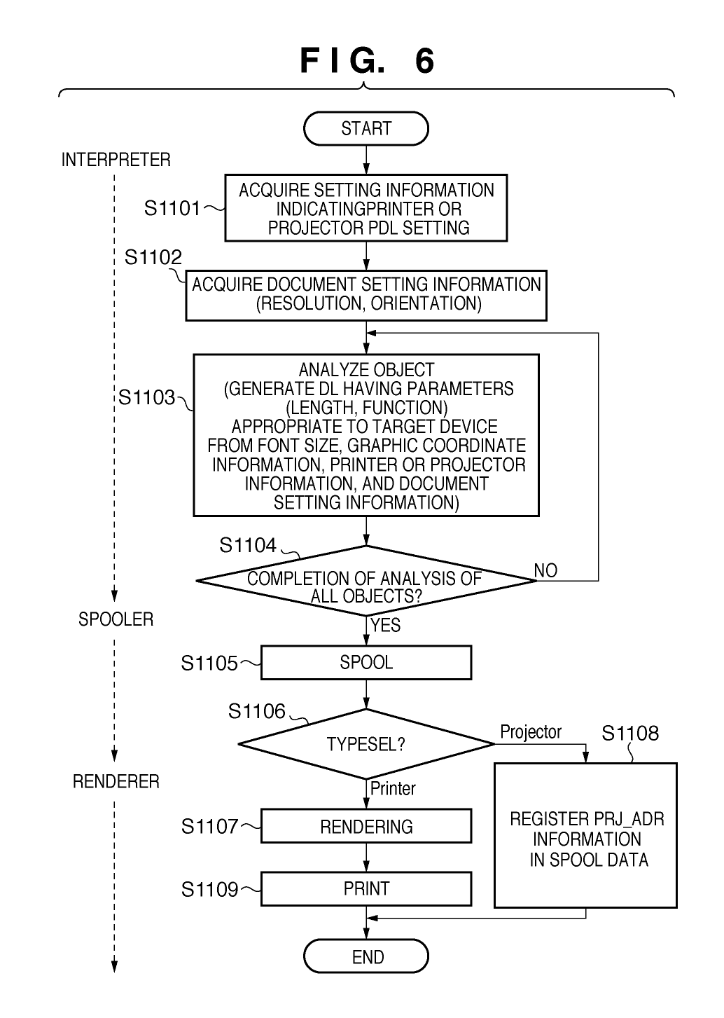

An operation executed when PDL output data from the host computer 11 is output using the printing apparatus 12 will be described below. In the printer 12, when PDL data is output from the host computer 11 via the network 14, the NIC 208 receives the data, acquires an access right of the data bus 204 via the I/F control unit 207, and sends the PDL data to the RAM 203. The CPU 201 analyzes the received PDL data to generate intermediate data called display list data (DL) after analysis. The CPU 201 rasterizes a raster image from the DL and outputs it from the printer unit in case of a print operation. FIG. 6 is a flowchart showing the PDL data analysis, image rasterization, and print processes. Note that arrows on the left side of FIG. 6 indicate main bodies of the processes.

In step S1101, the CPU 201 acquires output destination setting information from device setting commands described in the PDL data. In this embodiment, that information indicates the settings for either the printer or projector. After that, the process advances to step S1102. In step S1102, the CPU 201 acquires document setting information associated with a document (a resolution and orientation of the document to be generated) from document setting commands described in the PDL data. After that, the process advances to step S1103. In step S1103, the CPU 201 analyzes an object described in the document. The CPU 201 acquires a font size, and graphic coordinate information, and generates optimal DL used by the subsequent rendering unit 218 from the coordinate information, device setting information, and document setting information. After that, the process advances to step S1104. If the PDL data includes a plurality of objects, the CPU 201 determines in step S1104 if the next command to be analyzed indicates the end of a description of an object. If the next command is a command which describes the next object, the process returns to step S1103 to continue DL generation for the object to be analyzed. If analysis of all objects is complete, and the next command is a command which indicates the end of an object, the process advances to step S1105.

In step S1105, the DL generated in step S1103 is temporarily spooled in the RAM 203. In this embodiment, there are a plurality of output destinations, that is, the printer and projector. Hence, the subsequent steps are different depending on whether the output destination is the printer or projector. If “TYPESEL” (C3 in FIG. 5) in the device setting commands acquired in step S1101 describes “Printer” in step S1106, the process advances to step S1107; if it describes “Projector”, the process advances to step S1108. In step S1107, when the printer is set as the output destination, the spooled data is read out, and is rendered by the rendering unit 218. Then, raster image data to be output to the printer is generated. After that, the process advances to step S1109. In step S1108, when the projector is set as the output destination, address information (PRJ_ADR information) of the output projector is set in the spooled data, thus ending the operation of the printer 12. In this way, upon reception of a sending request from the projector, the printer can execute the data output processing. Note that the PRJ_ADR information may use PDL data which is generated by the information processing apparatus and is appended with IP address information of the projector. Alternatively, the PRJ_ADR information may be held in advance as information of the projector to which spool data is to be provided, and may be switched according to a user's designation. In addition, the PRJ_ADR information may have a file format, or may be acquired by referring to, for example, an external database via the network. Details of an operation executed when data is output from the printer 12 to the projector 13 will be described later in the next section. In step S1109, the raster image data generated in step S1107 is output to the printer unit 217 via the printer I/F 216.

[Operation Sequence of Projector in Display Mode]

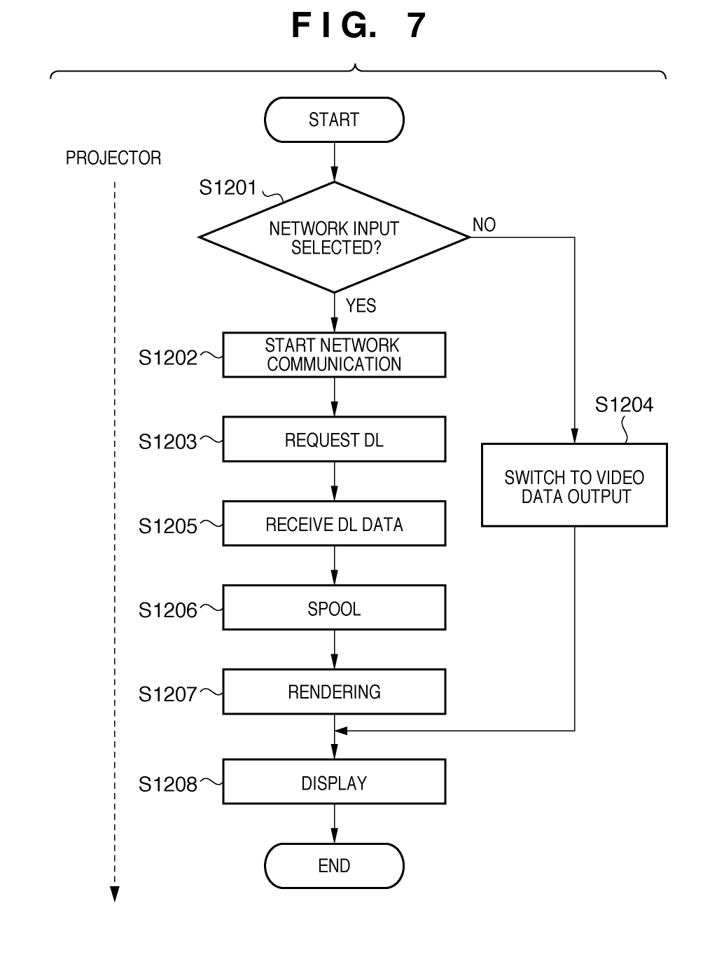

The operation sequence executed when data sent from the host computer 11 to the printer 12 is displayed by the projector 13 will be described below. The data sending sequence from the host computer to the printer 12 is the same as that in the aforementioned print operation sequence. Therefore, an operation from a state in which the DL data is already spooled in the printer 12 will be described. FIG. 7 is a flowchart of processing for displaying data by the projector.

In step S1201, the display control unit 311 of the projector 13 prompts the user to select an input signal to be displayed using the operation unit 307. Assume that this embodiment includes two inputs, that is, data reception (network communication) from the aforementioned printer 12 and a Video data input. If the user selects a data input from the I/F control unit 305 (that is, network communication), the process advances to step S1202; if he or she selects an input from the Video I/F unit 312 (that is, Video data input), the process advances to step S1204. In step S1202, the CPU 301 starts a communication with the printer 12 which spools data to be displayed via the network 14. After that, the process advances to step S1203. In step S1203, after a communication with the CPU 201 of the printer 12 is established, the CPU 301 issues a display request of image data spooled in the printer 12. After that, the process advances to step S1205.

If the user selects display of an input signal from the Video I/F unit 312 in step S1204, the CPU 301 instructs the display control unit 311 to output an input signal from the Video I/F unit 312 to the display unit 310. After that, the process advances to step S1208. In step S1205, the projector 13 receives the spooled DL data, which is sent from the printer 12 in response to the image data display request from the projector 13, via the NIC 306. After that, the process advances to step S1206. In step S1206, the received DL data is spooled in the RAM 303 via the data bus 304. After that, the process advances to step S1207. In step S1207, the rendering unit 309 renders the spooled DL data to bitmap data at a resolution and tonality optimized to the characteristics of the display unit 310 of the projector. After that, the process advances to step S1208. In step S1208, the display control unit 311 sends the bitmap image rendered by the rendering unit 309 or a video signal input from the Video I/F unit 312 to the display unit 310, which projects the input image onto the external screen. In this way, since data to be received by the projector is DL data before rendering, resolution-independent data can be exchanged.

As described above, in place of receiving bitmap data for the printer, which is rendered by the printer 12, the projector includes the rendering function, and generates a bitmap image suited to the characteristics of the display apparatus (projector) by itself, thus allowing to display an image having sharp outlines of characters and excellent tone reproducibility. Likewise, by applying image processing using an image processing function of an MFP, an image, which has a higher definition than an output display upon directly receiving image data from the PC in the conventional system, can be displayed. Upon controlling the MFP and project to cooperate, a user interface of, for example, a PC, which is used so far, is not required, and the same user interface as that of the MFP can be used, thus improving the user's convenience.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-181967, filed Aug. 4, 2009, which is hereby incorporated by reference herein in its entirety.

What is claimed is:

1. An information processing apparatus for generating output data to be output to a printing apparatus, which executes print processing or output processing to a display apparatus according to a definition described in the output data, comprising:
a holding unit which holds information of the printing apparatus as port information of the printing apparatus, and holds information of the printing apparatus as port information of the display apparatus;
a describing unit which describes, in the output data, a definition indicating that the display apparatus outputs the output data when the display apparatus is designated as an output destination of the output data, and a definition indicating that the printing apparatus outputs the output data when the printing apparatus is designated as an output destination of the output data; and
an output unit which outputs the output data to the printing apparatus.

2. A printing apparatus connected to a display apparatus and an information processing apparatus according to claim 1, comprising:
an analysis unit which generates intermediate data by analyzing output data received from the information processing apparatus;
a determination unit which determines based on a definition described in the output data whether the printing apparatus or the display apparatus outputs the output data; and
a sending unit which associates information of the display apparatus with the intermediate data of the output data generated by said analysis unit, and sends the intermediate data in response to a request of the display apparatus, when it is determined that the display apparatus outputs the output data.

3. An image processing cooperation system including a printing apparatus according to claim 2, and a display apparatus, wherein
the printing apparatus sets information of the display apparatus as an output destination in output data, an output destination of which is the display apparatus, and
the display apparatus comprises:
a request unit which requests the printing apparatus to send the intermediate data set with the information of the display apparatus; and
a display unit which displays the intermediate data which is sent from the printing apparatus according to the request of said request unit.

4. A control method of an information processing apparatus for generating output data to be output to a printing apparatus, which executes print processing or output processing to a display apparatus according to a definition described in the output data, comprising:
an output port information holding step of controlling an output port information holding unit of the information processing apparatus to hold pieces of information of output ports for the printing apparatus and the printing apparatus, which are designated by the user;
a describing step of controlling a describing unit of the information processing apparatus to describe, in the output data, a definition indicating that the display apparatus outputs the output data when the display apparatus is designated as an output destination of the output data, and a definition indicating that the printing apparatus outputs the output data when the printing apparatus is designated as an output destination of the output data; and
an output step of controlling an output unit of the information processing apparatus to output the output data to the printing apparatus.

5. A control method of a printing apparatus connected to a display apparatus and an information processing apparatus according to claim 1, comprising:
an analysis step of controlling an analysis unit of the printing apparatus to generate intermediate data by analyzing output data received from the information processing apparatus;
a determination step of controlling a determination unit of the printing apparatus to determine based on a definition defined in the output data whether the printing apparatus or the display apparatus outputs the output data;
a setting step of controlling a setting unit of the printing apparatus to associate information of the display apparatus with the intermediate data of the output data generated in the analysis step, when it is determined in the determination step that the display apparatus outputs the output data; and
a sending step of controlling a sending unit of the printing apparatus to send the information set in the setting step and the intermediate data in response to a request of the display apparatus.

6. A computer-readable medium storing a program, the program making a computer function as:
an output port information holding unit which holds pieces of information of output ports for the printing apparatus and the printing apparatus, which are designated by the user;
a describing unit which describes, in the output data, a definition indicating that the display apparatus outputs the output data when the display apparatus is designated as an output destination of the output data, and a definition indicating that the printing apparatus outputs the output data when the printing apparatus is designated as an output destination of the output data; and
an output unit which outputs the output data to the printing apparatus.

7. A computer-readable medium storing a program, the program making a printing apparatus function as:
an analysis unit which generates intermediate data by analyzing output data received from an information processing apparatus;
a determination unit which determines based on a definition defined in the output data whether the printing apparatus or a display apparatus outputs the output data; and
a sending unit which associates information of the display apparatus with the intermediate data of the output data generated by said analysis unit, and sends the intermediate data in response to a request of the display apparatus, when said determination unit determines that the display apparatus outputs the output data.
